(19) United States
(12) Patent Application Publication
(10) Pub. No.: US 2013/0073708 A1
(43) Pub. Date: Mar. 21, 2013

(54) TECHNIQUES FOR ACHIEVING UNLIMITED PARALLEL SCALABILITY, STORAGE CAPACITY, AND/OR STORAGE PERFORMANCE IN A MULTI-TENANT STORAGE CLOUD ENVIRONMENT

(71) Applicants: Felix Xavier, Bangalore (IN); Umasankar Mukkara, Bangalore (IN); Ratna Kiran Mova, Bangalore (IN)

(72) Inventors: Felix Xavier, Bangalore (IN); Umasankar Mukkara, Bangalore (IN); Ratna Kiran Mova, Bangalore (IN)

(73) Assignee: CLOUDBYTE, INC., SAN MATEO, CA (US)

(21) Appl. No.: 13/622,013

(22) Filed: Sep. 18, 2012

(30) Foreign Application Priority Data
Sep. 20, 2011 (IN) 3239/CHE/2011

(51) Int. Cl. G06F 15/173

(52) U.S. Cl. 709/223

(57) ABSTRACT

Techniques for achieving parallel scalability, storage capacity, and improved storage performance in a multi-tenant storage cloud environment are presented. A Tenant Storage Machine (TSM) of a tenant for the multi-tenant storage cloud environment is portable and can be dynamically detached from one or more storage controllers and dynamically moved to provide scalability, capacity, and improved storage performance.

### RELATED APPLICATIONS

The present application is co-pending with and claims foreign priority to Indian Provisional Patent Application No. 3239/CHE/2011 entitled: “Architecture for Achieving Parallel Scalability in Cloud Storage Environment,” filed with the Indian Patent Office on Sep. 20, 2011, the disclosure of which is incorporated by reference herein in its entirety.

### BACKGROUND

Cloud computing is rapidly changing the Internet into a collection of clouds, which provide a variety of computing resources, storage resources, and, in the future, a variety of resources that are currently unimagined.

Specifically, cloud computing is a technology infrastructure that facilitates: supplementing, consuming, and delivering Information Technology (IT) services. The cloud environment provides elastic provisioning of dynamically scalable virtual services.

A tenant is considered as a subscriber of some amount of storage in the cloud or an application who owns part of the shared storage environment. Multi-tenancy is an architecture where a single instance of software runs on a server, which is serving multiple tenants. In a multi-tenant environment, all tenants and their users consume the service from a same technology platform, sharing all components in the technology stack including the data model, servers, and database layers. Further, in a multi-tenant architecture, the data and configuration is virtually partitioned and each tenant works with a customized virtual application instance.

In any large scale storage deployment, there is a need to support the management of storage. In a Cloud Service Provider environment, it could easily extend to petabytes of data. However, the device, which manages the storage (namely the storage controller), is limited by the hardware resources on the amount of storage it can support. Typically, a storage controller can support up to hundreds of Terabytes of data. Hence, in a large scale deployment of storage, there is a need for tens of such storage controllers to exist together either independently supporting hundreds of terabytes or together supporting petabytes of storage. The important aspect in this large scale deployment is that the Cloud Service Provider cannot provision all the storage or all the storage controllers in the beginning and wishes to do so incrementally, based on the demand. In a deployment, where the requirement is to add the storage and storage controllers in an incremental fashion, the management of such storage needs to be kept simple and flexible. This becomes even more complicated if the storage needs be multi-tenant. Often, it becomes difficult to meet the expectations of the end users if a given storage service needs more capacity or more speed (more Input/Output Operations Per Second (IOPS) or more throughput or less latency).

Today, the scalability in a multi-tenant storage environment is achieved through independent management of storage controllers. The storage capacity that a storage controller supports can vary from vendor to vendor (ranging from few terabytes to few petabytes when the storage controllers are pooled together). However, current technologies have limitations doing the management of such scalable storage systems on a per tenant basis. For example, a particular tenant's data may be started with one controller and may slowly spread across Just a Bunch of Disks (JBODs) connected to multiple storage controllers. If a Cloud Service Provider or a data center administrator wants to move to the disks of the storage controller, the job becomes difficult for the administrator and it may involve coordination from multiple administrators. Current technologies have another significant limitation of increasing the performance of a given storage end point of a given customer. Once a storage end point is provisioned, its capacity can be increased to some extent but the performance is fixed. Its performance parameters such as IOPS, throughput, and latency cannot be increased if a need arises.

### SUMMARY

Various embodiments of the invention provide techniques for achieving parallel scalability, storage capacity, and storage performance in a multi-tenant storage cloud environment. Specifically, and in one embodiment a method for improving storage performance in a multi-tenant storage cloud environment is presented.

More particularly and in an embodiment, a request is received within a multi-tenant storage cloud environment to move a Tenant Storage Machine (TSM) from an original storage node. Next, a target storage node is identified for the TSM. Finally, the TSM is dynamically moved from the original storage node to the target storage node.

### BRIEF DESCRIPTION OF THE DRAWINGS

FIG. 1A is a diagram depicting an example architecture for achieving parallel scalability, storage capacity, and storage performance in a multi-tenant storage cloud environment, according to embodiments presented herein.

FIG. 1B is a diagram depicting a technique for adding a new tenant to a multi-tenant storage cloud environment using the architecture of the FIG. 1A, according to embodiments presented herein.

FIG. 1C is a diagram depicting a technique for increasing storage capacity and storage performance using the architecture of the FIG. 1A, according to embodiments presented herein.

FIG. 1D is a diagram depicting a tenant administrator's view of storage control resources in a cloud storage environment, according to embodiments presented herein.

FIG. 2 is a diagram of a method for improving storage performance in a multi-tenant storage cloud environment is presented, according to embodiments presented herein.

FIG. 3 is a diagram of another method for improving storage performance in a multi-tenant storage cloud environment is presented, according to embodiments presented herein.

FIG. 4 is a diagram of a multi-tenant storage performance system, according to embodiments presented herein.

### DETAILED DESCRIPTION

A “resource” includes a user, service, system, device, directory, data store, groups of users, a file, a file system, combinations and/or collections of these things, etc. A “principal” is a specific type of resource, such as an automated service or user that acquires an identity. As used herein a “principal” may be used synonymously and interchangeably with the term “tenant.”

A “processing environment” defines a set of cooperating computing resources, such as machines (processor and memory-enabled devices), storage, software libraries, software systems, etc. that form a logical computing infrastructure. A “logical computing infrastructure” means that computing resources can be geographically distributed across a network, such as the Internet. So, one computing resource at network site X and be logically combined with another computing resource at network site Y to form a logical processing environment.

The phrases “processing environment,” “cloud processing environment,” “cloud environment,” and the term “cloud” may be used interchangeably and synonymously herein.

Moreover, it is noted that a “cloud” refers to a logical and/or physical processing environment as discussed above.

The techniques presented herein are implemented in machines, such as processor or processor-enabled devices (hardware processors). These machines are configured and programmed to specifically perform the processing of the methods and systems presented herein. Moreover, the methods and systems are implemented and reside within a non-transitory computer-readable storage media or machine-readable storage medium and are processed on the machines configured to perform the methods.

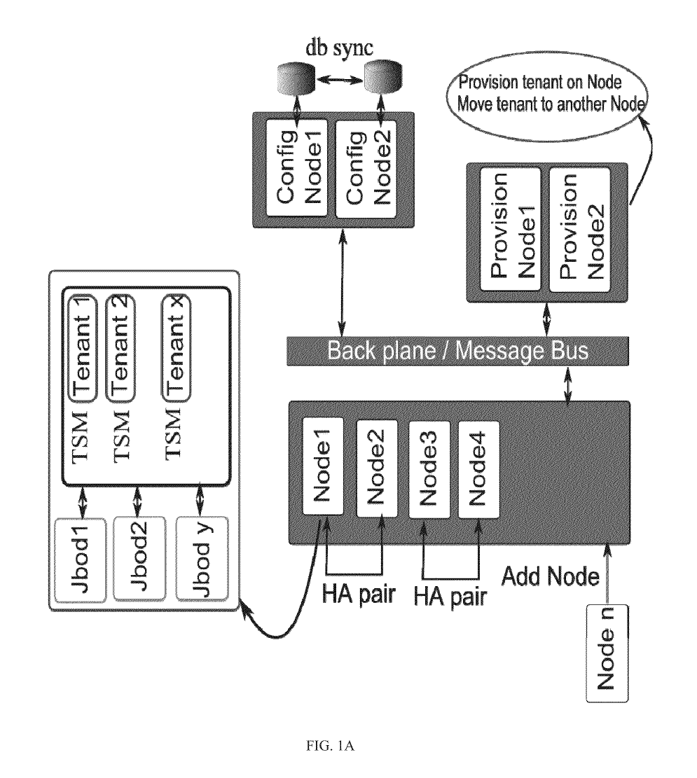

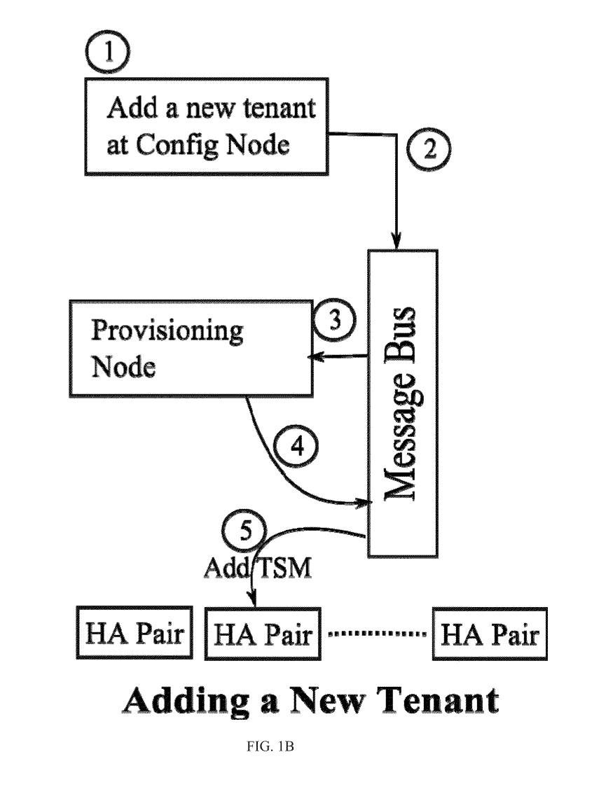

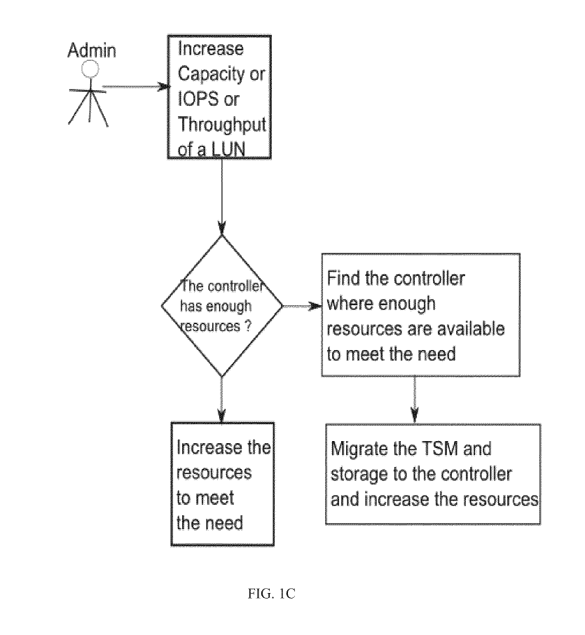

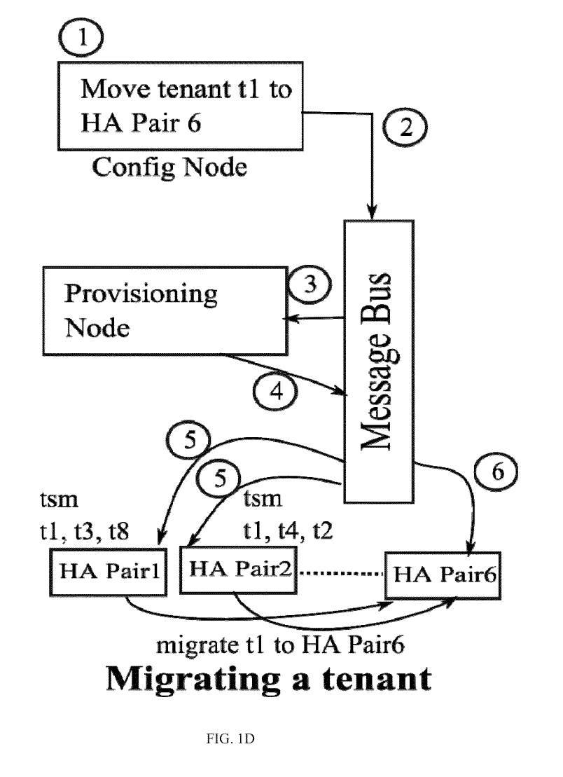

It is within this context that embodiments of the invention are now discussed within the context of the FIGS. 1-4.

FIG. 1A is a diagram depicting an example architecture for achieving parallel scalability, storage capacity, and storage performance in a multi-tenant storage cloud environment, according to embodiments presented herein. It is noted that the architecture is presented as one example embodiment as other arrangements and elements are possible without departing from the teachings presented herein.

As will become more apparent with the discussions and illustrations presented herein, the architecture of the FIG. 1A provides for a variety of benefits, such as the following.

The techniques prescribe mechanisms for adding storage capacity or storage performance of a given customer (tenant) in a multi-tenant storage deployment to provide parallel scalability to an unlimited extent. This approach also prescribes a technique by which a Tenant Storage Machines (TSM) can be created and moved dynamically from one controller to another in a seamless fashion.

The techniques also define the architecture for resolving the aforementioned problems. The architecture (the FIG. 1A) and techniques given herein enable the storage administrator to increase the capacity of a storage end point or performance of storage end point.

The embodiments herein are able to overcome the aforementioned issues of managing parallel scalability of storage capacity and storage performance in the storage controllers by prescribing a centralized management module that is responsible for identifying the storage controller on which a TSM can be brought up and dynamically moved across the storage controller nodes. The approach prescribes an architecture (the FIG. 1A) where the complete details of a tenant's storage is confined to a TSM and that TSM can be very easily moved across multiple storage controllers. The approach also defines a technique in which a storage controller pair can be added to the centralized system without having to alter the existing design and configuration of the storage controllers. When a TSM is provisioned on a controller and if a need arises to increase either capacity, IOPS, throughput, or to decrease the storage latency, firstly an attempt is made to adjust the storage controller resources dynamically. In case the resources are exhausted on that particular controller, the TSM is moved seamlessly to another physical controller where this need can be met.

Now referring to the FIG. 1A, the architecture includes a pair of configuration nodes, a pair of provisioning nodes and a cluster of High Availability (HA) node pairs.

### Description of HA Node Pair

HA of tenant storage services is provided by pairing two storage controller nodes together. An HA pair is treated as a storage controller node that provides HA of storage services for a particular tenant. The architecture allows running a tenant storage services on more than one HA node pairs.

### Description of Configuration Node

The configuration of TSM is stored in a centralized database called a configuration node module. The configuration nodes are deployed in a cluster pair for redundancy and fault tolerance. The database associated with the configuration node is synchronized with another configuration node.

### Description of Provisioning Node

The provisioning node is a major component in the architecture. The provisioning node is responsible for the following:
1) identifying the HA node pair on which a newly created TSM is going to be provisioned;
2) bringing a newly added HA node pair into the system;
3) managing the communication among the TSMs of a particular tenant that are spread across multiple HA node pairs; and
4) migrating storage services and storage of a particular tenant onto a new storage controller HA node pair.

FIG. 1B is a diagram depicting a technique for adding a new tenant to a multi-tenant storage cloud environment using the architecture of the FIG. 1A, according to embodiments presented herein.

The FIG. 1 B shows a process/method of creating a tenant and associating the TSM to a HA node pair.

As shown in the FIG. 1B, all the modules communicate through a common message bus. Each module has registered with the message bus and receives commands from message bus through call back function calls. The following are the various processing involved in adding a new tenant to the architecture (the FIG. 1A):
1) a global administrator or a Cloud Service Provider (CSP) administrator defines a new tenant and adds that definition at the configuration node;
2) a new add-TSM message is generated and passed to the message bus with the provisioning node as the receiver;
3) provisioning node receives a call back for the TSM-add message, and determines which HA node pair is suited for the provisioning of the TSM;
4) upon determination of the target HA node pair, the add-TSM message is sent to the message bus with the corresponding HA node pair as the destination; and
5) the target HA node pair receives the add-TSM message and provisions the TSM—once the TSM is provisioned it continues to run the storage services on the same HA node air until further change commands are received by the HA node pair.

FIG. 1C is a diagram depicting a technique for increasing storage capacity and storage performance using the architecture of the FIG. 1A, according to embodiments presented herein.

The FIG. 1 C illustrates a process/method of increasing storage capacity or storage performance for a given TSM.

A storage Logical Unit Number (LUN) that is assigned to a customer typically has “Capacity” as a manageable parameter. The approaches herein “storage performance” to also be identified as manageable by finding a suitable storage controller where enough resources are available and then migrating the TSM to that controller and assigning the required resources.

FIG. 1D is a diagram depicting a tenant administrator's view of storage control resources in a cloud storage environment, according to embodiments presented herein.

The FIG. 1D illustrates a process/method of tenant (TSM) migration to a new controller.

As explained in the FIG. 1D, upon receiving a tenant migration request of T1 to HA node pair 6, the provisioning node sends out messages to all the HA node pairs where the TSMs belonging to T1 are present. In the above example, HA node pair 1 and HA node pair 2 are holding TSMs of T1. In 5, the messages are received by the HA node pairs to migrate the TSMs to HA node pair 6. Once the migration is done, commands to HA node pair 6 is sent (6) via the message bus. At the end of 6, all the TSMs belonging to T1 are running on HA node pair 6.

The above description and the description that follows provide the following benefits:
The architecture (FIG. 1A) in which a storage controller can be added in parallel to increase the storage processing capacity of a storage system.
The method of adding a tenant at the configuration node and the TSM being provisioned on an independent controller.
The method of allowing TSMs belonging to a particular tenant on multiple HA node pairs.
The mechanism of using a HA node pair for the purposes of HA of storage services in the scalable storage system.
The method of migrating the multiple TSMs of a particular tenant to a new HA node pair without the loss of data.
The mechanism of using the available small storage of multiple tenants and migrating to a different storage medium of choice at a later time without the loss of data.
The mechanism of using a message bus for the communication among multiple modules.
The method of adding new HA node pairs to a system in parallel resulting in unlimited storage capacity both in terms of storage space and storage processing.
The mechanism of dynamically increasing storage performance of a storage LUN apart from the typical storage capacity. The storage performance parameters include IOPS, throughput and latency.
The mechanism of adjusting storage controller resources as a means to achieve increased IOPS, throughout of a LUN.
The mechanism of dynamically migrating the TSM and corresponding storage to a suitable controller to increase either capacity or performance of a storage LUN.

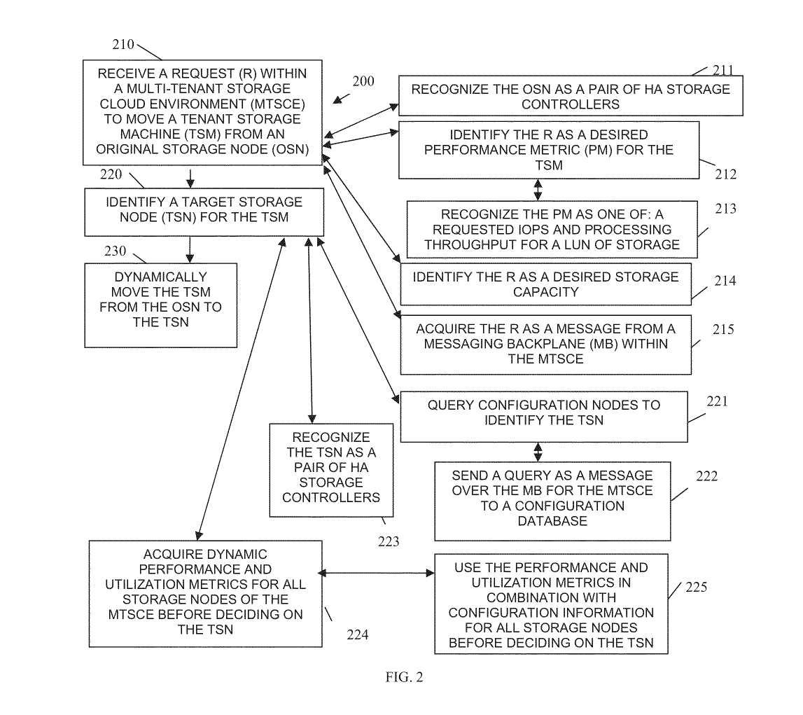

FIG. 2 is a diagram of a method 200 for improving storage performance in a multi-tenant storage cloud environment is presented, according to embodiments presented herein. The method 200 (herein referred to as “storage manager”) is implemented, programmed, and resides within a non-transitory machine-readable storage medium that executes on one or more processors of a network. The network may be wired, wireless, or a combination of wired and wireless.

In an embodiment, the storage manager is deployed and utilizes the architecture and approaches presented above with respect to the FIGS. 1A-1D.

At the outset it is noted that a Tenant Storage Machine (TSM) is akin to a Virtual Machine (VM) that is dynamically instantiated when a tenant requests storage on the cloud storage environment. This TSM permits novel control and isolation of the tenant and its services and storages to that of other tenants operating within the cloud storage environment.

At 210, the storage manager receives a request within a multi-tenant storage cloud environment. A multi-tenant storage cloud environment is a storage environment in a cloud environment that services multiple tenants. The request is to move a particular tenant's TSM from an original storage node (storage controller).

According to an embodiment, at 211, the storage manager recognizes the original storage node as a pair of HA storage controllers, as was discussed at length above with reference to the FIGS. 1A-1D.

In another case, at 212, the storage manager identifies the request as a desired performance metric for the TSM.

Continuing with the embodiment of 212 and at 213, the storage manager recognizes the performance metric as one of: a requested IOPS and a desired processing throughput for a LUN of storage.

In still another case, at 214, the storage manager identifies the request as a desired storage capacity.

In yet another situation, at 215, the storage manager acquires the request as a message from a messaging backplane within the multi-tenant storage cloud environment. This was presented and described with reference to the FIGS. 1A, 1B, and 1D.

At 220, the storage manager identifies a target storage node for the TSM. That is, the storage manager decides on where the TSM is going to be dynamically relocated.

According to an embodiment, at 221, the storage manager queries configuration nodes to identify the target storage node. This was presented in the FIG. 1A.

Continuing with the embodiment of 221 and at 222, the storage manager sends a query as a message over a messaging backplane for the multi-tenant storage cloud environment. Again, shown above in the FIGS. 1A, 1B, and 1D.

In one case, at 223, the storage manager recognizes the target storage node as a pair of HA storage controllers.

In yet another situation, at 224, the storage manager acquires dynamic performance and utilization metrics for all storage nodes of the multi-tenant storage cloud environment before deciding on the target storage node.

Continuing with the embodiment of 224 and at 225, the storage manager uses the performance and utilization metrics in combination with configuration information for all the storage nodes before deciding on the target storage node.

At 230, the storage manager dynamically moves the TSM from the original storage node to the target storage node. This too was described above with reference to the FIGS. 1A-1D.

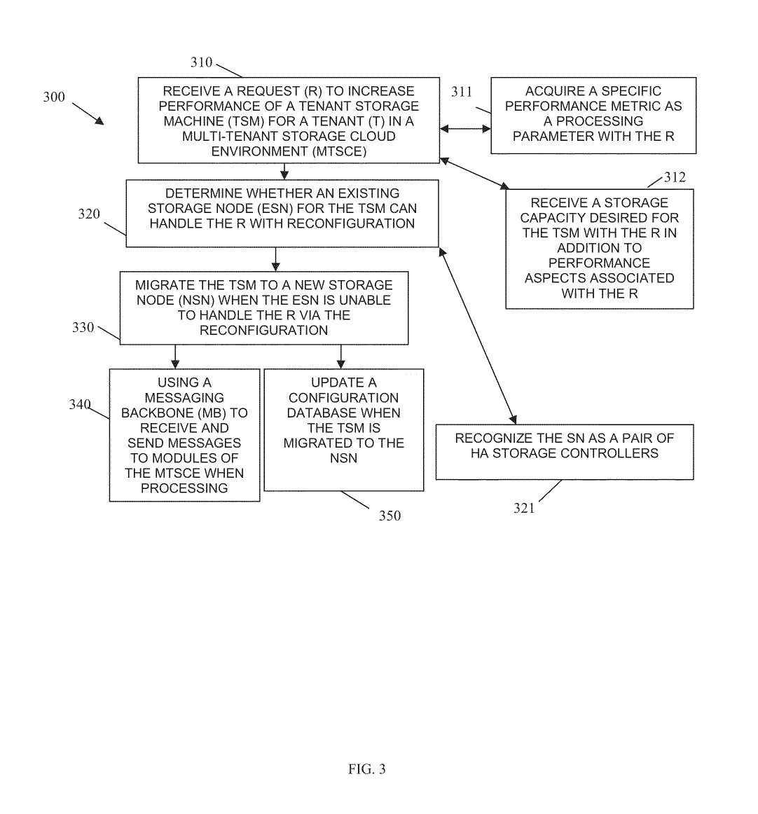

FIG. 3 is a diagram of another method 300 for improving storage performance in a multi-tenant storage cloud environment is presented, according to embodiments presented herein. The method 300 (herein referred to as “storage enhancer”) is implemented, programmed, and resides within a non-transitory machine-readable storage medium that executes on one or more processors of a network. The network may be wired, wireless, or a combination of wired and wireless.

The storage enhancer presents an enhanced perspective of the storage manager represented by the method 200 of the FIG. 2. Moreover, the storage enhancer is implemented or deployed within the architecture and approaches shown in the FIGS. 1A-1D.

At 310, the storage enhancer receives a request to increase performance of a TSM for a tenant in a multi-tenant storage cloud environment.

In an embodiment, at 311, the storage enhancer acquires a specific performance metric as a processing parameter with the request.

In another situation, at 312, the storage enhancer receives a storage capacity desired for the TSM with the request in addition to performance aspects associated with the request.

At 320, the storage enhancer determines whether an existing storage node for the TSM can handle the request with reconfiguration and if so then the request is so satisfied.

According to an embodiment, at 321, the storage enhancer recognizes the storage node as a pair of HA storage controllers.

At 330, the storage enhancer migrates the TSM to a new storage node when the existing storage node is unable to handle the request via reconfiguration.

In an embodiment, at 340, the storage enhancer uses a messaging backbone to receive and send messages to modules of the multi-tenant storage cloud environment when the storage enhancer processes.

In another case, at 350, the storage enhancer updates a configuration database when the TSM is migrated to a new storage node.

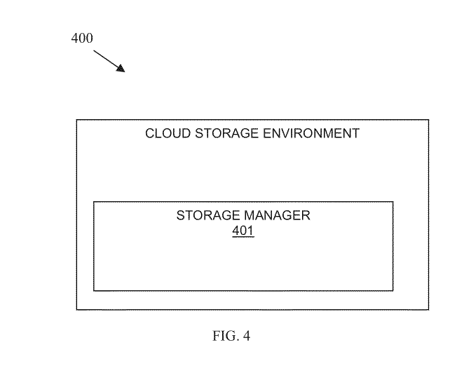

FIG. 4 is a diagram of a multi-tenant storage performance system 400, according to embodiments presented herein. The components of the multi-tenant storage performance system 400 are implemented, programmed, and reside within a non-transitory machine-readable storage medium that executes on one or more processors of a network. The network may be wired, wireless, or a combination of wired and wireless.

In an embodiment, the multi-tenant storage performance system 400 implements, inter alia, the processing associated with the methods 200 and 300 of the FIGS. 2 and 3, respectively using the architecture and approaches provided by the FIGS. 1A-1D.

The multi-tenant storage performance system 400 includes a cloud storage environment having a storage manager 401.

The multi-tenant storage performance system 400 includes a cloud storage environment that has one or more processors, memory, and storage.

The memory of the cloud storage environment is configured with the storage manager 401, which is implemented as executable instructions that process on one or more processors of the cloud storage environment. Example processing associated with the storage manager 401 was presented above in detail with reference to the FIGS. 1A-1D, 2, and 3.

The storage manager 401 is configured to dynamically move a TSM from an original storage controller to a new storage controller within the cloud storage environment. The cloud storage environment is a multi-tenant storage cloud environment that services multiple tenants where each tenant is associated with a unique TSM.

According to an embodiment, the cloud storage environment organizes pairs of existing storage controllers to act as one in HA pairs.

Continuing with the previous embodiment, the storage manager 401 is further configured to dynamically add new pairs and remove existing pairs from the cloud storage environment.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented in a non-transitory machine-readable storage medium and processed by one or more processors of a machine configured to perform the method, comprising:
receiving, from the machine, a request within a multi-tenant storage cloud environment to move a Tenant Storage Machine (TSM) from an original storage node;
identifying, from the machine, a target storage node for the TSM; and
dynamically moving, from the machine, the TSM from the original storage node to the target storage node.

2. The method of claim 1, wherein receiving further includes recognizing the original storage node as a pair of high availability storage controllers.

3. The method of claim 1, wherein receiving further includes identifying the request as a desired performance metric for the TSM.

4. The method of claim 3, wherein identifying further includes recognizing the performance metric as one of: a requested Input/Output operations per second and processing throughput for a logical unit of storage.

5. The method of claim 1, wherein receiving further includes identifying the request as a desired storage capacity.

6. The method of claim 1, wherein receiving further includes acquiring the request as a message from a messaging backplane within the multi-tenant storage cloud environment.

7. The method of claim 1, wherein identifying further includes querying configuration nodes to identify the target storage node.

8. The method of claim 7, wherein querying further includes sending a query as a message over a messaging backplane for the multi-tenant storage cloud environment to a configuration database.

9. The method of claim 1, wherein identifying further includes recognizing the target storage node as a pair of high availability storage controllers.

10. The method of claim 1, wherein identifying further includes acquiring dynamic performance and utilization metrics for all storage nodes of the multi-tenant storage cloud environment before deciding on the target storage node.

11. The method of claim 10, wherein acquiring further includes using the performance and utilization metrics in combination with configuration information for all the storage nodes before deciding on the target storage node.

12. A method implemented in a non-transitory machine-readable storage medium and processed by one or more processors of a machine configured to perform the method, comprising.
receiving, on the machine, a request to increase performance of a tenant storage machine (TSM) for a tenant in a multi-tenant storage cloud environment;
determining, on the machine, whether an existing storage node for the TSM can handle the request with reconfiguration; and
migrating, on the machine, the TSM to a new storage node when the existing storage node is unable to handle the request via the reconfiguration.

13. The method of claim 12 further comprising, using, via the machine, a messaging backbone to receive and send messages to modules of the multi-tenant storage cloud environment when processing the method.

14. The method of claim 12 further comprising, updating, via the machine, a configuration database when the TSM is migrated to the new storage node.

15. The method of claim 12, wherein receiving further includes acquiring a specific performance metric as a processing parameter with the request.

16. The method of claim 12, wherein receiving further includes receiving a storage capacity desired for the TSM with the request in addition to performance aspects associated with the request.

17. The method of claim 12, wherein determining further includes recognizing the storage node as a pair of high availability storage controllers.

18. A system, comprising:
a cloud storage environment having one or more processors, memory, and storage, the cloud storage environment situated in a cloud environment and accessed over a network; and
the memory configured with a storage manager implemented as executable instructions that process on the one or more processors of the cloud storage environment;
wherein the storage manager is configured to dynamically move a tenant storage machine (TSM) from an original storage controller to a new storage controller within the cloud storage environment, and the cloud storage environment is a multi-tenant storage cloud environment servicing multiple tenants, each tenant associated with a unique TSM.

19. The system of claim 18, wherein the cloud storage environment organizes pairs of existing storage controllers to act as one in high available pairs.

20. The system of claim 19, wherein the storage manager is configured to dynamically add new pairs and remove existing pairs from the cloud storage environment.
